(19) United States
(12) Patent Application Publication
(10) Pub. No.: US 2019/0301606 A1
(43) Pub. Date: Oct. 3, 2019

(54) LUBRICATION FEATURE FOR PIN OF TWO STROKE PISTON ASSEMBLY

(71) Applicant: Federal-Mogul LLC, Southfield, MI (US)

(72) Inventor: Michael WEINENGER, Southfield, MI (US)

(21) Appl. No.: 15/942,359

(22) Filed: Mar. 30, 2018

(51) Int. Cl. F16J 1/16; F16J 1/08; B23P 15/10

(52) U.S. Cl. CPC F16J 1/16; F16J 7/00; B23P 15/10; F16J 1/08

(57) ABSTRACT

A pin including recesses extending longitudinally between opposite ends, and a piston assembly including the pin, for a two-stroke engine, is provided. The recesses preferably have a radius of curvature less than a radius of curvature of the remaining outer surface of the pin. The pin is rotationally fixed relative to the connecting rod. As the connecting rod swings back and forth during operation, some of the recesses rotate beyond the load bearing region of the pin joint where oil is located, allowing oil to fill the recesses. As the pin swings back, these recesses carrying the oil enter the load bearing region of the pin joint, transferring the oil with them. Preferably, at least one of the recesses aligns with an oil opening in the pin, which aligns with an oil hole in the connecting rod, to receive and distribute oil along the full length of the pin.

### BACKGROUND OF THE INVENTION

### 1. Field of the Invention

This invention relates generally to piston assemblies of internal combustion engines, and methods of manufacturing the piston assemblies.

### 2. Related Art

Piston assemblies for internal combustion engines typically include a piston fixed to a connecting rod by a pin. The pin extends through a pin bore of the piston and a bore of the connecting rod at the joint between the connecting rod, pin, and piston. A significant benefit to pin joint lubrication in a four-stroke internal combustion engine is that when during the end of an exhaust stroke and an intake stroke, the loading on the pin changes such that the pin which was, during the compression and power strokes, forced against the upper portion of the pin bore (i.e. nearer the crown of the piston) is now forced against the lower portion of the pin bore (i.e. further from the crown of the piston). This movement allows oil to flow between the upper portion of the pin bore and the pin and thus prevent scuffing of the pin bore.

However, in a two-stroke engine, where the exhaust and intake strokes are combined with the compression and power strokes, there are conditions at which the pin is not forced against the lower portion of the pin bore. This makes it exceedingly difficult to properly lubricate the pin joint and makes a two-stroke engine, especially one using high cylinder pressure, more prone to pin joint scuffing than the four-stroke engine. An improvement to pin joint lubrication in two-stroke engines is needed.

### SUMMARY

One aspect of the invention provides a pin for a two-stroke internal combustion engine capable of improving lubrication of load bearing pin bores surfaces of a piston. The pin extends longitudinally along a pin axis from a first pin end to a second pin end, and the pin has an outer surface extending around the pin axis. The outer surface includes a plurality of recesses extending longitudinally between the first pin end and the second pin end. The outer surface also includes a cylindrical portion presenting a cylindrical shape which spaces the recesses from one another. Each recess extends inwardly from the cylindrical portion toward the pin axis, and each recess has a curved shape.

Another aspect of the invention provides a piston assembly for a two-stroke internal combustion engine. The piston assembly includes a connecting rod and a pin. The connecting rod extends longitudinally from a first rod end to a second rod end, and the connecting rod includes a first rod bore adjacent the first rod end. The pin is disposed in the first rod bore of the connecting rod. The pin extends longitudinally along a pin axis from a first pin end to a second pin end, and the pin has an outer surface extending around the pin axis. The outer surface of the pin includes a plurality of recesses and a cylindrical portion, wherein the recesses are spaced from one another by the cylindrical portion, and the cylindrical portion presents a cylindrical shape. The recesses extend longitudinally between the first end and the second end, each recess extends inwardly from the cylindrical portion toward the pin axis, and each recess has a curved shape.

Yet another aspect of the invention provides a method of manufacturing a pin for a two-stroke internal combustion engine. The method includes forming a pin, the pin extending longitudinally along a pin axis from a first pin end to a second pin end, the pin having an outer surface extending around the pin axis, the outer surface including a plurality of recesses and a cylindrical portion spacing the recesses from one another, the cylindrical portion presenting a cylindrical shape, the recesses extending longitudinally between the first pin end and the second pin end, each of the recesses extending inwardly from the cylindrical portion toward the pin axis, and each of the recesses having a curved shape.

Yet another aspect of the invention includes a method of manufacturing a piston assembly for a two-stroke internal combustion engine. The method comprises the steps of disposing a pin in a first rod bore of a connecting rod. The pin extends longitudinally along a pin axis from a first pin end to a second pin end, the pin having an outer surface extending around the pin axis, the outer surface including a plurality of recesses and a cylindrical portion, the recesses being spaced from one another by the cylindrical portion, the cylindrical portion presenting a cylindrical shape, the recesses extending longitudinally between the first end and the second end, each of the recesses extending inwardly from the cylindrical portion toward the pin axis, and each of the recesses having a curved shape.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a cross-sectional side view of a two-stroke internal combustion engine including a piston assembly according to an example embodiment;

FIG. 2 is a side view of a connecting rod and pin which can be used in a two-stroke internal combustion engine according to an example embodiment;

FIG. 3 is a cross-sectional view of the connecting rod and pin of FIG. 2;

FIG. 4 is a front view of a connecting rod and pin according to an example embodiment;

FIG. 5 is a cross-sectional view of the connecting rod and pin of FIG. 4;

FIG. 6 is a perspective view of a pin for a two-stroke internal combustion engine according to an example embodiment;

FIG. 7 is an enlarged view of recesses formed in a portion of the pin according to an example embodiment; and

FIG. 8 is a perspective view of a pin for a two-stroke internal combustion engine according to another example embodiment.

### DETAILED DESCRIPTION OF EXAMPLE EMBODIMENTS

One aspect of the invention provides a pin 20 for a piston assembly 22 of a two-stroke internal combustion engine 24 The pin can be rotationally fixed to a connecting rod 26 and disposed in pin bores 28 of a piston 30 for reciprocating movement in a cylinder bore 32 or chamber of the two-stroke internal combustion engine. The pin includes a plurality of recesses 34, also referred to as pockets, formed in an outer surface 36 of the pin for containing a cooling medium, typically cooling oil. As the connecting rod swings back and forth during operation the pin rotates. During rotation, some of the recesses will rotate beyond a load bearing region of a joint between the pin and pin bore surfaces 38 of the piston, allowing oil to fill the recesses. As the pin swings back in the opposite direction, these recesses carrying oil enter the load bearing region of the joint, transferring with them oil into these regions. Thus, the pin is able to improve lubrication of the pin bores surfaces of the piston at the load bearing region.

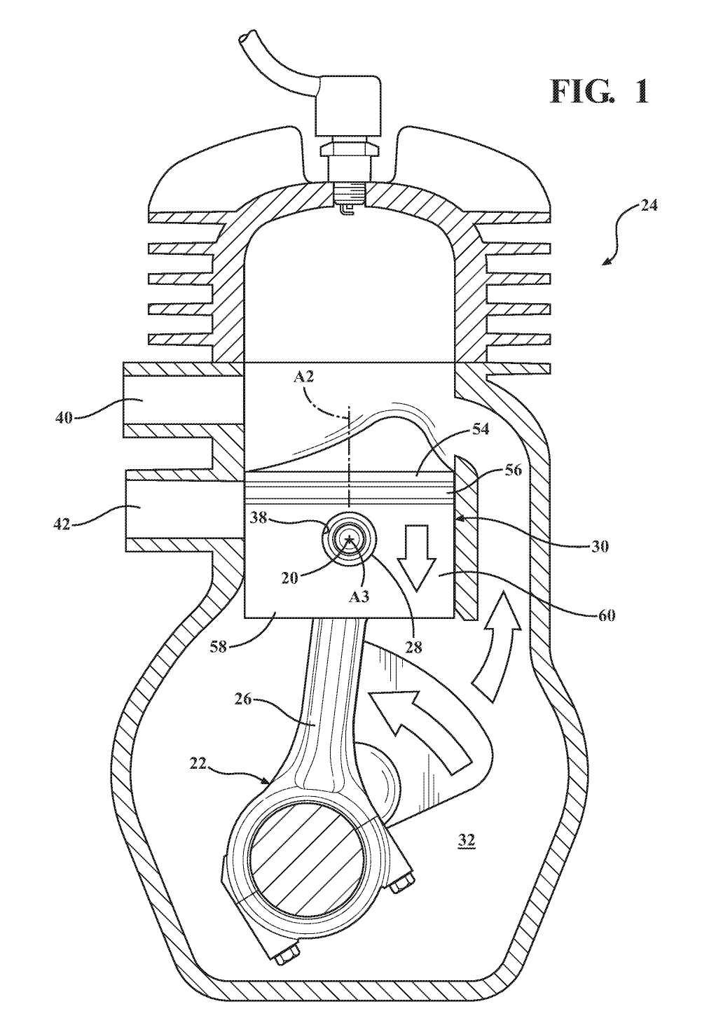

An example of the two-stroke internal combustion engine including the pin with the recesses distributed about the circumference of the pin is shown in FIG. 1. The engine can be a light vehicle diesel, mid-range diesel, heavy duty and large bore diesel engine, or gas engine, for example. The two-stroke (or two-cycle) internal combustion engine completes a power cycle with two strokes, e.g. up and down movements, of the piston during only one crankshaft revolution. In addition to the piston, connecting rod, and pin, the two-stroke internal combustion engine typically includes a crankcase for gas exchange, an intake port 40, and an exhaust port 42. A significant feature of the two-stroke internal combustion engine is that the piston acts not only as a piston, but also a compressor, an intake, and an exhaust valve. The two-stroke combustion engine has the inlet and exhaust ports rather than valves. Thus, skirt sections of the piston are used to seal the combustion chamber and are used as intake and exhaust valves when the piston reciprocates in the cylinder bore of the two-stroke internal combustion engine.

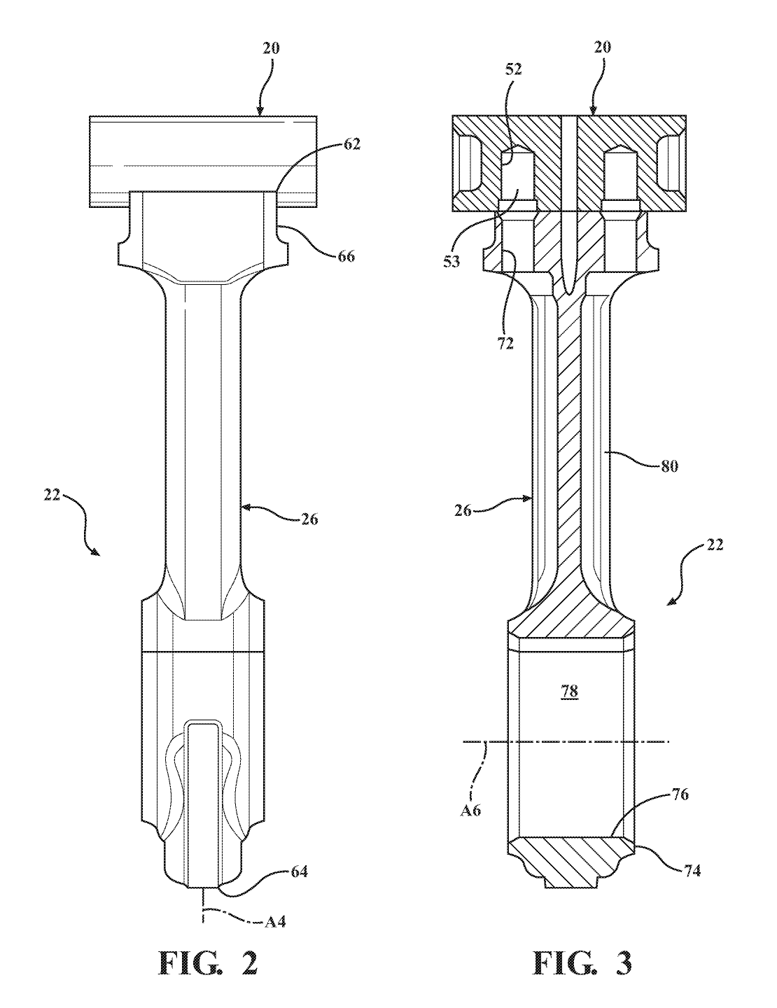

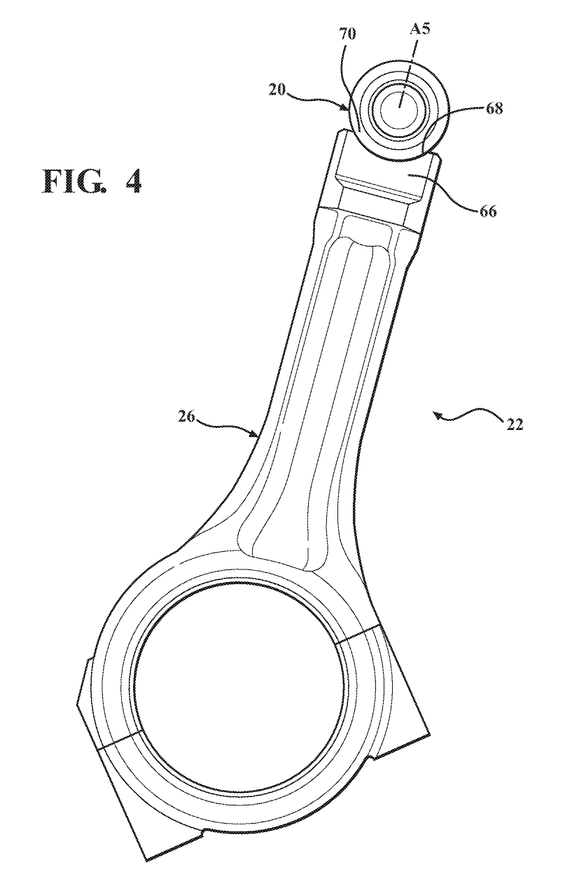

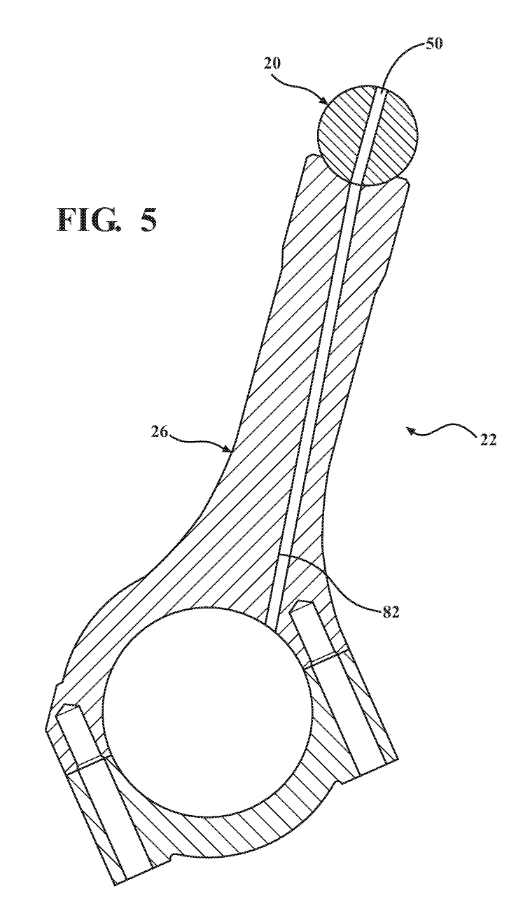

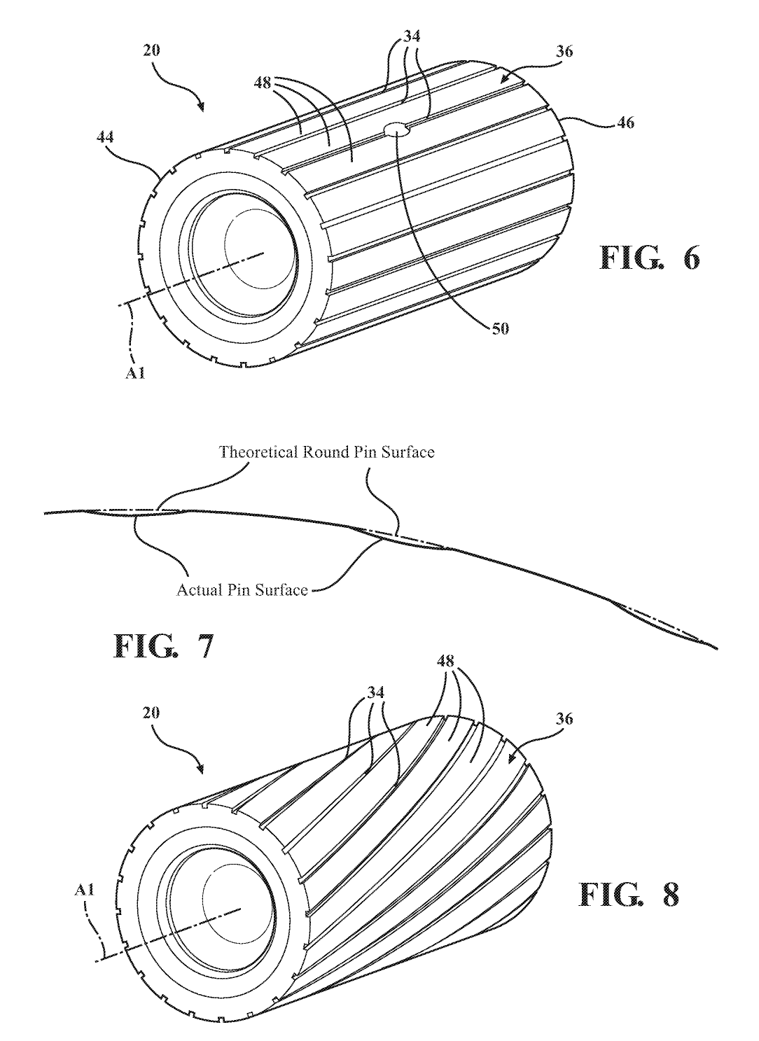

As shown in FIGS. 2-5, the pin with recesses which distribute oil along the pin bore surfaces and provide improved lubrication to the pin bore surfaces, is rotationally fixed to the connecting rod. As shown in FIG. 2, the pin extends longitudinally along a pin axis Al from a first pin end 44 to a second pin end 46. The pin axis is a single axis, which makes the pin easier and less expensive to manufacture, machine, and assemble in the piston assembly compared to pins having more than one axis. The outer surface of the pin extends around the pin axis. The outer surface includes the plurality of recesses, typically at least three recesses, but the number of recesses can be more or less. As best shown in FIG. 6, the outer surface also includes a cylindrical portion 48 presenting a cylindrical shape and spacing the recesses from one another. According to the embodiments of FIGS. 6 and 8, the recesses are equally spaced from one another and are disposed continuously about the pin axis. Alternatively, the pin can include three recesses all near the top of the pin, for example one at 12 o'clock, one at approximately 2 o'clock, and one at approximately 10 o'clock. The 2 and 10 o'clock positions could be calculated according to the specifics of the design.

As shown in the drawings, the recesses extend longitudinally between the first pin end and the second pin end. Preferably, the recesses extend continuously from the first pin end to the second pin end and are open at the pin ends. In the embodiment of FIG. 6, each recess extends in a straight line from the first pin end to the second pin end. In the embodiment of FIG. 8, each recess extends in a spiral shape from the first pin end to the second pin end.

As shown in FIG. 7, each recess extends inwardly from the cylindrical portion toward the pin axis. Each recess has a curved or concave shape relative to the cylindrical portion of the outer surface, which has a convex shape. Preferably, each recess has a radius of curvature which is less than a radius of curvature of the cylindrical portion of the outer surface.

The pin can also include an oil opening 50 for conveying oil. The oil opening is aligned with at least one of the recesses and extends through the pin. For example, the oil opening can be drilled into the pin and extend from a first one of the recesses to a second one of the recesses, where the first and second recesses are disposed diametrically opposite one another. Alternatively, the oil opening can extend from one of the recesses through the pin and to the cylindrical portion. The pin also typically includes at least one pin bolt hole 52 extending from the outer surface toward the pin axis for receiving a bolt 53 to rotationally fix the pin to the connecting rod. The pin is formed of metal, for example steel.

Referring back to FIG. 1, the piston assembly further includes the piston formed of a metal material, for example a steel material. The piston can have various different designs. However, in the example embodiment, the piston extends longitudinally along a piston axis A2, and the piston includes a crown 54 having a combustion surface. The piston of the example embodiment also includes a ring belt 56 depending from the combustion surface, the ring belt presents a cylindrical shape extending circumferentially around the pin axis and includes a plurality of ring grooves spaced longitudinally from one another by lands.

The piston also includes a pair of pin bosses 58 depending from the ring belt and presenting the pin bores. The pin bores are coaxially aligned along a pin bore axis A3 extending transversely to the piston axis. The pin bores present the pin bore surfaces extending circumferentially around the pin bore axis. As stated above, portions of the pin bore surfaces are load bearing regions during operation of the engine and thus more prone to scuffing and wear. The skirt sections depend from the ring belt and space the pin bosses from one another. The skirt sections also present a convex shape for sliding cooperation within the cylinder bore. The pin bosses and the skirt sections are connected by struts 60.

As shown in FIGS. 1-5, the connecting rod of the example embodiment extends longitudinally along a rod axis A4 from a first rod end 62 to a second rod end 64. The connecting rod is formed of a metal material, such as steel. The connecting rod includes a first thrust portion 66 at the first rod end. The first thrust portion includes a first bore surface 68 extending circumferentially around a first bore axis A5 and presents a first bore 70. The first bore axis extends transversely to the rod axis. In the example embodiment, the first thrust portion includes a rod bolt hole 72 extending inwardly from the first bore surface. The rod bolt hole can receive the bolt for bolting the connecting rod to the pin and thus rotationally fixing the pin relative to the first bore surface.

The connecting rod also includes a second thrust portion 74 at the second rod end. The second thrust portion includes a second bore surface 76 extending circumferentially around a second bore axis A6 and presenting a second bore 78. The second bore axis extends transversely to the rod axis. The second bore has a diameter which is greater than a diameter of the first bore, such that the second bore can receive a crank shaft of the engine.

The connecting rod also includes a stem 80 connecting the first thrust portion to the second thrust portion. In the example embodiment, the connecting rod includes an oil hole 82 extending continuously from the second bore through the stem to the first bore for conveying the cooling oil to the oil opening of the pin for distribution along the pin bores surfaces of the piston.

Once the piston assembly of the preferred embodiment is assembled, the oil opening of the pin is aligned with the oil hole of the connecting rod for allowing oil to flow from the oil hole in the connecting rod to the oil opening in the pin. The pin is coupled to the connecting rod and the piston such that the pin extends through a first one of the pin bores of the piston, then through the first bore of the connecting rod, and finally through a second one of the pin bosses of the piston. The pin axis of the pin is a single axis aligned with the pin bore axis of the piston.

According to the preferred embodiment, the bolt is disposed in the rod bolt hole and in the pin bolt hole to fix the connecting rod to the pin and prevent the pin from rotating relative to the first bore surface of the connecting rod. The pin may not disengage an upper portion of the pin bore surfaces at times during operation, but the pin is able to rotate relative to the pin bore surfaces. As the connecting rod swings back and forth during operation of the engine, the pin will rotate. During rotation, the pin rotates such that some of the recesses of the outer surface of the pin will rotate beyond the load bearing region of the pin joint where oil is located, allowing oil to fill the recesses. As the pin swings back in the opposite direction, these recesses carrying the oil enter the load bearing region of the pin joint, transferring with them oil into these regions. Additionally, in the preferred embodiment, since at least one of the recesses aligns with the oil opening in the pin, the recess is able to distribute this supply of oil to the full length of the pin.

Another aspect of the invention provides a method of manufacturing a pin. The method includes forming the pin, for example by casting, forging, extrusion, and/or machining, to achieve the design described above. For example, the pin can be formed so that the outer surface presents the cylindrical shape, and then the recesses can be machined in the outer surface. The oil opening can be formed by drilling through the pin. However, other methods can be used to form the pin.

Another aspect of the invention provides a method of manufacturing the piston assembly for the two-stroke internal combustion engine, as described above. The method includes forming the pin, typically by casting, forging, extrusion, machining, and/or drilling. The method can also include forming the piston and connecting rod using various different steps, for example casting, forging, machining, welding, and/or drilling. However, other methods can be used to manufacture the piston and connecting rod.

Once the pin, connecting rod, and piston are formed or otherwise provided, the method includes coupling the pin to the piston and the connecting rod. This step can include aligning the first bore of the connecting rod with the pin bores of the piston. The pin is inserted through a first one of the pin bosses, then the first bore of the connecting rod, and next through a second one of the pin bosses. The process of coupling the pin to the connecting rod also preferably includes fixing or attaching the pin to the first bore surface and thus preventing the pin from rotating relative to the first bore surface of the connecting rod. In the example embodiment, this step includes bolting the pin to the connecting rod by disposing a bolt in the pin bolt hole of the pin and the rod bolt hole of the connecting rod.

Obviously, many modifications and variations of the present invention are possible in light of the above teachings and may be practiced otherwise than as specifically described while within the scope of the following claims. In particular, all features of all claims and of all embodiments can be combined with each other, as long as they do not contradict each other.

1. A pin for a two-stroke internal combustion engine,
said pin extending longitudinally along a pin axis from a first pin end to a second pin end,
said pin having an outer surface extending around said pin axis,
said outer surface including a plurality of recesses and a cylindrical portion spacing said recesses from one another,
said cylindrical portion presenting a cylindrical shape,
said recesses extending longitudinally between said first pin end and said second pin end,
each of said recesses extending inwardly from said cylindrical portion toward said pin axis, and
each of said recesses having a curved shape.

2. A pin according to claim 1, wherein each of said recesses of said outer surface has a radius of curvature which is less than a radius of curvature of said cylindrical portion of said outer surface.

3. A pin according to claim 1, wherein said recesses extend continuously from said first pin end to said second pin end.

4. A pin according to claim 1, wherein said recesses are open at said first pin end and at said second pin end.

5. A pin according to claim 1 including an oil opening extending from a first one of said recesses to a second one of said recesses for conveying oil, and said first and second recesses are disposed diametrically opposite one another.

6. A pin according to claim 1 including at least one pin bolt hole extending from said outer surface toward said pin axis.

7. A piston assembly for a two-stroke internal combustion engine, comprising:
a connecting rod extending longitudinally from a first rod end to a second rod end, said connecting rod including a first rod bore adjacent said first rod end;
a pin disposed in said first rod bore of said connecting rod, said pin extending longitudinally along a pin axis from a first pin end to a second pin end, said pin having an outer surface extending around said pin axis, said outer surface including a plurality of recesses and a cylindrical portion, said recesses being spaced from one another by said cylindrical portion, said cylindrical portion presenting a cylindrical shape, said recesses extending longitudinally between said first end and said second end, each of said recesses extending inwardly from said cylindrical portion toward said pin axis, and each of said recesses having a curved shape.

8. A piston assembly according to claim 7 including an attachment fixing of said pin to said connecting rod and preventing said pin from rotating relative to said connecting rod.

9. A piston assembly according to claim 8, wherein said attachment includes at least one bolt.

10. A piston assembly according to claim 7, wherein each of said recesses of said pin has a radius of curvature which is less than a radius of curvature of said cylindrical portion of said pin.

11. A piston assembly according to claim 7, wherein said pin includes an oil opening extending from a first one of said recesses to a second one of said recesses for conveying oil, and said first and second recesses are disposed diametrically opposite one another.

12. A piston assembly according to claim 11, wherein said connecting rod includes a second bore adjacent said second end, said connecting rod includes an oil hole extending continuously from said first bore to said second bore, and said oil hole of said connecting rod is aligned with said oil opening of said pin.

13. A piston assembly according to claim 7 including a piston, said piston including a pair of pin bosses each presenting a pin bore, and said pin is disposed in said pin bores on said piston.

14. The piston assembly of claim 7 further comprising:
a piston formed of a steel material and extending longitudinally along a piston axis,
said piston including a crown having a combustion surface and a ring belt depending from said combustion surface,
said ring belt presenting a cylindrical shape extending circumferentially around said pin axis and including a plurality of ring grooves spaced longitudinally from one another by lands,
said piston including a pair of pin bosses depending from said ring belt and each including a pin bore,
said pin bores being coaxially aligned along a pin bore axis extending transversely to said piston axis,
said pin bores presenting a bore surface extending circumferentially around said pin bore axis,
said piston including a pair of skirt sections depending from said ring belt and spacing said pin bosses from one another,
said skirt sections presenting a convex shape for sliding cooperation within a cylinder bore,
said pin bosses and said skirt sections being connected by struts,
said connecting rod being formed of a steel material and extending longitudinally along a rod axis from said first end to said second rod end,
said connecting rod including a first thrust portion at said first rod end,
said first thrust portion including a first bore surface extending circumferentially around a first bore axis and presenting said first bore,
said first bore axis extending transversely to said rod axis,
said first thrust portion including at least one rod bolt hole extending inwardly from said first bore surface,
said connecting rod including a second thrust portion at said second rod end,
said second thrust portion including a second bore surface extending circumferentially around a second bore axis and presenting said second bore,
said second bore axis extending transversely to said rod axis,
said second bore having a diameter being greater than a diameter of said first bore,
said connecting rod including a stem connecting said first thrust portion to said second thrust portion,
said connecting rod including an oil hole extending continuously from said second bore through said stem to said first bore for conveying oil,
said pin extending through a first one of said pin bores of said piston, through said first bore of said connecting rod, and through a second one of said pin bosses of said piston,
said pin axis of said pin being aligned with said pin bore axis of said piston,
said plurality of recesses of said pin including at least three recesses,
said recesses being equally spaced from one another about said pin axis,
said recesses extending continuously from said first pin end to said second pin end,
each of said recesses having concave shape relative to said cylindrical portion of said outer surface,
each of said recesses having a radius of curvature being less than a radius of curvature of said cylindrical portion of said outer surface,
said recesses being open at said first pin end and at said second pin end,
said first and second recesses being disposed diametrically opposite one another,
said oil opening of said pin being aligned with said oil hole of said connecting rod for allowing oil to flow from said oil hole to said oil opening,
said pin including at least one pin bolt hole extending from said outer surface toward said pin axis, and
a bolt disposed in said rod bolt hole and in said pin bolt hole,
said bolt fixing said connecting rod to said pin,
and said bolt preventing said pin from rotating relative to said first bore surface of said connecting rod.

15. A method of manufacturing a pin, comprising the steps of:
forming a pin, the pin extending longitudinally along a pin axis from a first pin end to a second pin end, the pin having an outer surface extending around the pin axis, the outer surface including a plurality of recesses and a cylindrical portion spacing the recesses from one another, the cylindrical portion presenting a cylindrical shape, the recesses extending longitudinally between the first pin end and the second pin end, each of the recesses extending inwardly from the cylindrical portion toward the pin axis, and each of the recesses having a curved shape.

16. A method according to claim 15, wherein the step of forming the pin includes casting, forging, extruding, machining, and/or drilling.

17. A method of manufacturing a piston assembly for a two-stroke internal combustion engine, comprising the steps of:
disposing a pin in a first rod bore of a connecting rod;
the pin extending longitudinally along a pin axis from a first pin end to a second pin end, the pin having an outer surface extending around the pin axis, the outer surface including a plurality of recesses and a cylindrical portion, the recesses being spaced from one another by the cylindrical portion, the cylindrical portion presenting a cylindrical shape, the recesses extending longitudinally between the first end and the second end, each of the recesses extending inwardly from the cylindrical portion toward the pin axis, and each of the recesses having a curved shape.

18. A method according to claim 17 including preventing the pin from rotating relative to the connecting rod by attaching the pin to the connecting rod.

19. A method according to claim 18, wherein the attaching step includes bolting.

20. A method according to claim 17 including disposing the pin in pin bores of a piston.
